(19) United States
(12) Patent Application Publication
(10) Pub. No.: US 2014/0126215 A1
(43) Pub. Date: May 8, 2014

(54) ILLUMINATION LAMP

(71) Applicant: WINTEK CORPORATION, Taichung City (TW)

(72) Inventor: Chong-Yang Fang, Taichung City (TW)

(73) Assignee: WINTEK CORPORATION, Taichung City (TW)

(21) Appl. No.: 14/067,995

(22) Filed: Oct. 31, 2013

(30) Foreign Application Priority Data
Nov. 2, 2012 (TW) 101140803

(51) Int. Cl. F21K 99/00

(52) U.S. Cl. CPC F21K 9/52
USPC 362/296.01

(57) ABSTRACT

An illumination lamp includes a transmissible lamp cover, a circuit board, and a side light emitting device. The transmissible lamp cover has an opening. The circuit board covers the opening. The side light emitting device includes a light guide pillar structure and a top-view light emitting diode. An inclined reflective layer is formed in the light guide pillar structure. The top-view light emitting diode is installed on the circuit board and disposed under the light guide pillar structure. Light emitted by the top-view light emitting diode is incident into the light guide pillar structure and then reflected by the inclined reflective surface, so that the light could be reflected laterally to the transmissible lamp cover.

### BACKGROUND OF THE INVENTION

1. Field of the Invention

The present invention relates to an illumination lamp, and more specifically, to an illumination lamp utilizing a side light emitting device to laterally emit light to a transmissible lamp cover. 2. Description of the Prior Art

A conventional lamp is an incandescent lamp which emits light by heating a tungsten filament disposed therein. In recent years, for achieving the environmental protection and energy saving purposes, an incandescent lamp has gradually been replaced by a light emitting diode lamp utilizing a light emitting diode as a light source. However, the light emitting diode lamp only has an illumination angle of about 120° due to the limited light emitting angle of the light emitting diode (about 120°), which is far less than that of the incandescent lamp (about 300°), so as to restrict the illumination application of the light emitting diode lamp. Although the illumination angle of the light emitting diode lamp could be increased by directly disposing a light emitting diode on a lamp cover of the light emitting diode lamp in the prior art, light could be easily leaked from a hole on the lamp cover for installation of the light emitting diode, so as to reduce efficiency of the light emitting diode lamp in use of light and cause a light leakage problem.

Furthermore, the aforesaid design could also make the manufacturing process of the light emitting diode lamp more complicated and cause the light emitting diode lamp to have a poor visual effect due to direct disposal of the light emitting diode on the lamp cover.

### SUMMARY OF THE INVENTION

The present invention provides an illumination lamp including a transmissible lamp cover, a circuit board, and a side light emitting device. The transmissible lamp cover has an opening. The circuit board covers the opening. The side light emitting device includes a light guide pillar structure and at least one top-view light emitting diode. The light guide pillar structure has an inclined reflective layer formed therein. The top-view light emitting diode is installed on the circuit board and disposed under the light guide pillar structure. Light emitted by the top-view light emitting diode is incident into the light guide pillar structure and then reflected by the inclined reflective layer, so that light could be incident into the transmissible lamp cover laterally.

The present invention further provides an illumination lamp including a transmissible lamp cover, a circuit board, and a side light emitting device. The transmissible lamp cover has an opening. The circuit board covers the opening. The side light emitting device includes at least one side-view light emitting diode and a casing. The side-view light emitting diode is installed on the circuit board for laterally emitting light to the transmissible lamp cover. The casing covers the side-view light emitting diode to package the side-view light emitting diode on the circuit board.

The present invention further provides an illumination lamp including a transmissible lamp cover, a circuit board, and at least one light emitting diode. The transmissible lamp cover is made of reflective material with a light reflectance greater than 90% and a light absorbance less than 1% and has an opening. The circuit board covers the opening. The light emitting diode is installed on the circuit board for emitting light to the transmissible lamp cover.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an internal diagram of an illumination lamp according to a first embodiment of the present invention.

FIG. 2 is an exploded diagram of a side light emitting device and a circuit board in FIG. 1.

FIG. 3 is an internal diagram of an illumination lamp according to a second embodiment of the present invention.

FIG. 4 is an internal diagram of an illumination lamp according to a third embodiment of the present invention.

### DETAILED DESCRIPTION

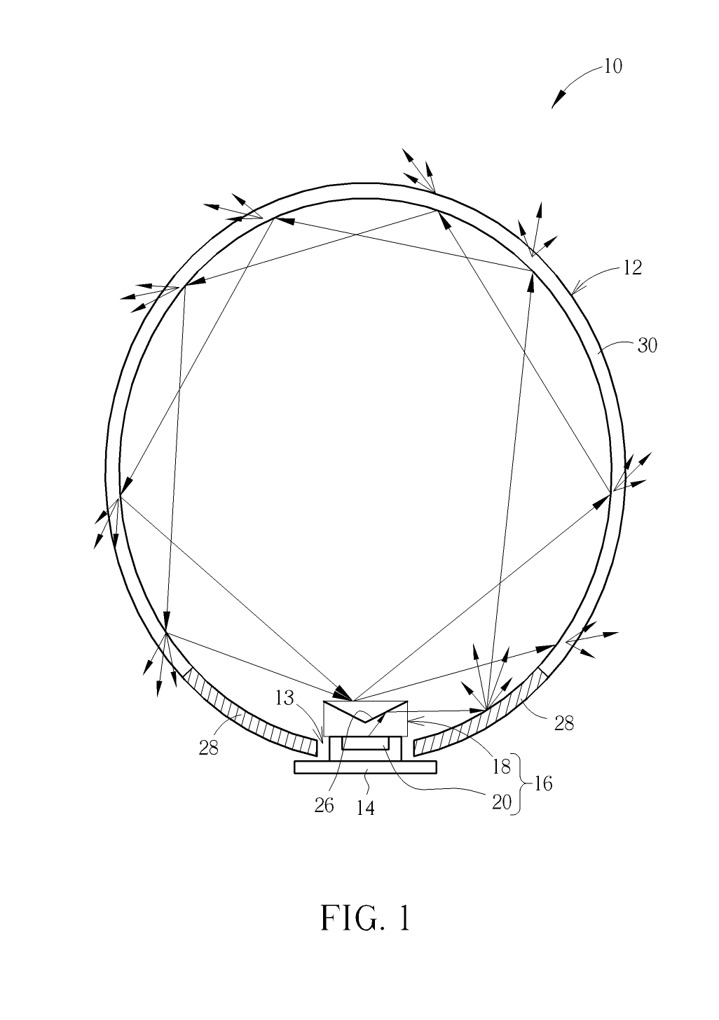

Please refer to FIG. 1, which is an internal diagram of an illumination lamp 10 according to a first embodiment of the present invention. As shown in FIG. 1, the illumination lamp 10 includes a transmissible lamp cover 12, a circuit board 14, and a side light emitting device 16. The transmissible lamp cover 12 has an opening 13. The circuit board 14 correspondingly covers the opening 13 to contain the side light emitting device 16 cooperatively with the transmissible lamp cover 12. The transmissible lamp cover 12 is made of reflective material with a light reflectance greater than 90% and alight absorbance less than 1%. The aforesaid light reflectance can be simply defined by the following equation.

Light Reflectance=1—(Light Absorbance+Light Transmittance)

In brief, when light is incident into an object, reflection, transmission, and absorption of light may occur. On the premise that amount of the incident light is equal to 1, light reflection efficiency of the object is higher if the light reflectance approaches 1. On the contrary, if the light reflectance is less than 0.5, it means that the object has a higher light absorbance and a higher light transmittance. In other words, the transmissible lamp cover 12 could be a lamp cover with high light reflection efficiency, so that multiple reflections of light could occur over the transmissible lamp cover 12. Accordingly, light emitted by the side light emitting device 16 could be incident into different positions on the transmissible lamp cover 12. Furthermore, the transmissible lamp cover 12 could be further made of light scattering material with a haze greater than 50%, meaning that the transmissible lamp cover 12 could be preferably made of material with high light reflectance and scattering efficiency (e.g. Microcellular Plastic, like Microcellular Polyethylene Terephthalate (PET)). In such a manner, scattering of light could further occur over the transmissible lamp cover 12 so as to make light passing through the transmissible lamp cover 12 have a more uniform brightness distribution.

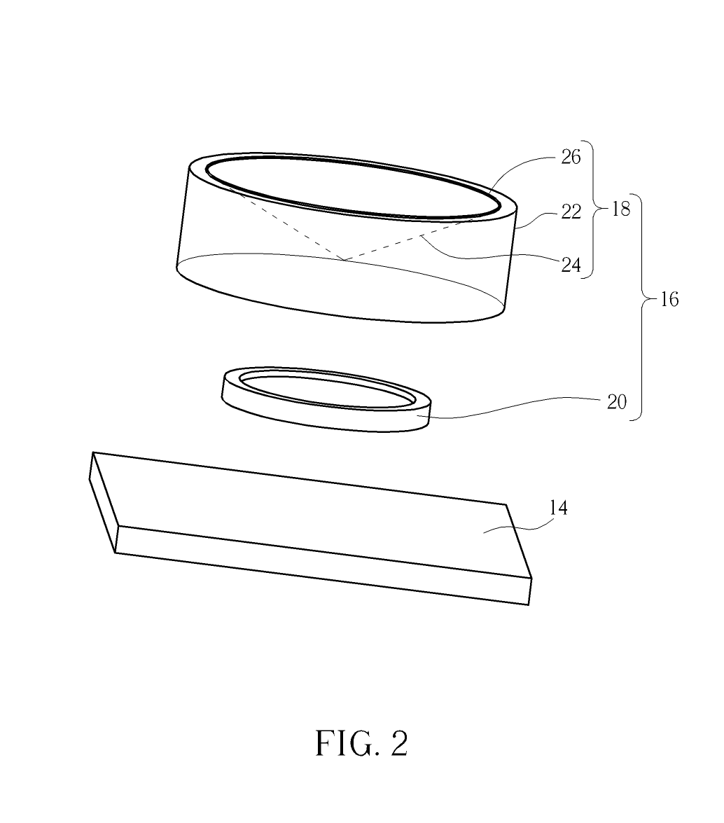

Please refer to FIG. 1 and FIG. 2. FIG. 2 is an exploded diagram of the side light emitting device 16 and the circuit board 14 in FIG. 1. As shown in FIG. 1 and FIG. 2, the side light emitting device 16 includes a light guide pillar structure 18 and at least one top-view light emitting diode 20 (one shown in FIG. 1, but not limited thereto). In this embodiment, the light guide pillar structure 18 includes a pillar body 22 and a recessed structure 24. The pillar body 22 is disposed on the top-view light emitting diode 20. The recessed structure 24 is formed on the pillar body 22, and an inclined reflective layer 26 is correspondingly formed on the recessed structure 24. Accordingly, the inclined reflective layer 26 could be used for reflecting light toward the top-view light emitting diode 20 back to the transmissible lamp cover 12, so as to solve the light leakage problem and increase efficiency of the illumination lamp 10 in use of light. Furthermore, since light emitted by the top-view light emitting diode 20 could be reflected by the pillar body 22 to be incident laterally into the transmissible lamp cover 12 via reflection of the inclined reflective layer 26, the purpose that light could be incident into a bottom region of the transmissible lamp cover 12 is achieved accordingly. Furthermore, the structural design of the light guide pillar structure 18 is not limited to the first embodiment. That is, in another embodiment, the light guide pillar structure 18 could be a solid structure having the inclined reflective layer 26 directly formed therein with omission of the recessed structure 24. As for which structural design is utilized, it depends on the practical application of the illumination lamp 10.

To be noted, in this embodiment, a light reflectance of a first region 28 of the transmissible lamp cover 12 relatively close to the side light emitting device 16 could be preferably greater than a light reflectance of a second region 30 of the transmissible lamp cover 12 relatively away from the side light emitting device 16. As for disposal of the first region 28 and the second region 30, it could be as shown in FIG. 1, but not limited thereto. Accordingly, the aforesaid lateral light could be reflected by the first region 28 due to the high light reflectance of the first region 28, so that the purpose of preventing the aforesaid lateral light from directly passing through the bottom region of the transmissible lamp cover 12 could be achieved. In such a manner, the illumination lamp 10 could surely prevent a bright area from occurring on the bottom region of the transmissible lamp cover 12.

Via the aforesaid designs, as shown in FIG. 1, when the top-view light emitting diode 20 emits light, light could enter the pillar body 22 and then be reflected laterally to the first region 28 of the transmissible lamp cover 12 when light is incident into the inclined reflective layer 26 on the recessed structure 24. Subsequently, due to high light reflection and scattering efficiency of the first region 28, reflection and scattering of light could occur on the first region 28 so as to keep light going on in the transmissible lamp cover 12. Finally, as shown in FIG. 1, light distribution in the transmissible lamp cover 12 could be more uniform via the high light scattering characteristic of the transmissible lamp cover 12, and multiple reflections of light could occur on the transmissible lamp cover 12 via the high light reflection characteristic of the transmissible lamp cover 12. In such a manner, light emitted by the top-view light emitting diode 20 could be incident into different positions on the transmissible lamp cover 12 uniformly, and partial transmission of light could occur at each light incident position on the transmissible lamp cover 12 (as shown in FIG. 1), so that the illumination lamp 10 could provide approximately omnidirectional illumination. Thus, the light emitting angle and light use efficiency of the illumination lamp 10 could be greatly increased.

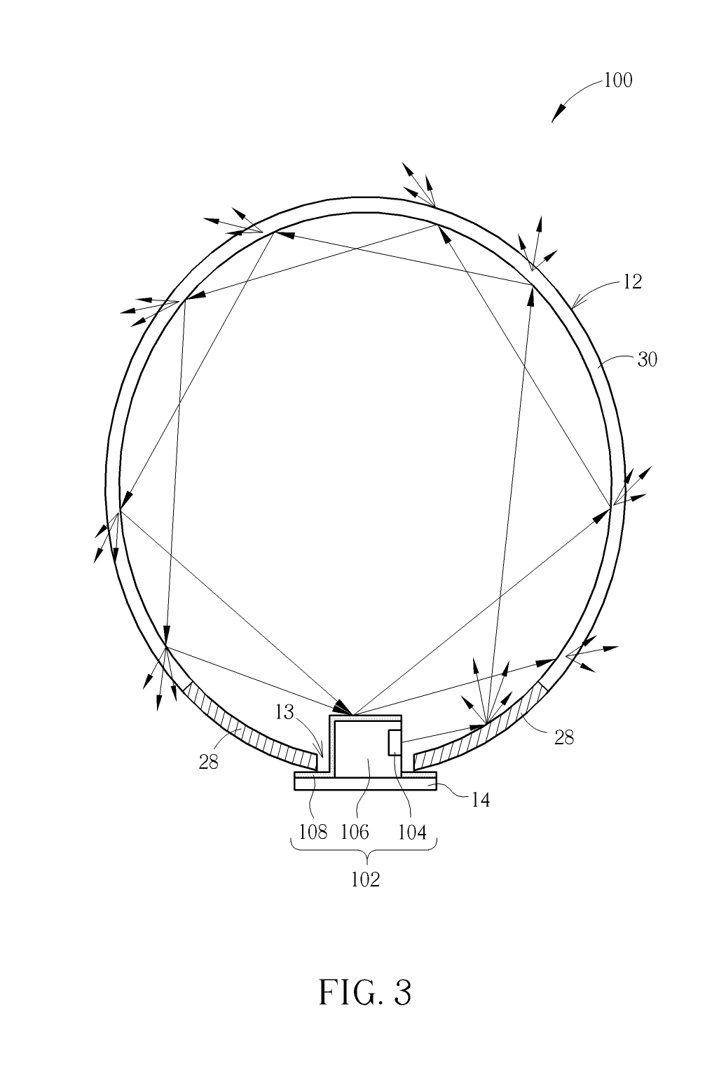

In the present invention, the design of the side light emitting device is not limited to the aforesaid embodiment. For example, please refer to FIG. 3, which is an internal diagram of an illumination lamp 100 according to a second embodiment of the present invention. Components both mentioned in the first embodiment and the second embodiment represent components with similar functions or structures, and the related description is therefore omitted herein. The major difference between the illumination lamp 100 and the illumination lamp 10 is the design of the side light emitting device. As shown in FIG. 3, the illumination lamp 100 includes the transmissible lamp cover 12, the circuit board 14, and a side light emitting device 102. In this embodiment, the side light emitting device 102 includes at least one side-view light emitting diode 104 (one shown in FIG. 3, but not limited thereto) and a casing 106. The side-view light emitting diode 104 is installed on the circuit board 14 for laterally emitting light to the transmissible lamp cover 12. The casing 106 covers the side-view light emitting diode 104 to package the side-view light emitting diode 104 on the circuit board 14. The casing 106 could be preferably made of high reflective material for reflecting light toward the side light emitting device 102 back to the transmissible lamp cover 12. Furthermore, in this embodiment, the side light emitting device 102 could further include a reflective layer 108. The reflective layer 108 is formed on the casing 106 and the circuit board 14 for further reflecting light toward the side light emitting device 102 back to the transmissible lamp cover 12.

Via the aforesaid designs, when the side-view light emitting diode 104 emits light, light could be laterally incident into the first region 28 of the transmissible lamp cover 12. Subsequently, due to high light reflection and scattering efficiency of the first region 28, reflection and scattering of light could occur on the first region 28 so as to keep light going on in the transmissible lamp cover 12. Finally, as shown in FIG. 3, light distribution in the transmissible lamp cover 12 could be more uniform via the high light scattering characteristic of the transmissible lamp cover 12, and multiple reflections of light could occur on the transmissible lamp cover 12 via the high light reflection characteristic of the transmissible lamp cover 12. In such a manner, light emitted by the side-view light emitting diode 104 could be incident into different positions on the transmissible lamp cover 12 uniformly, and partial transmission of light could occur at each light incident position on the transmissible lamp cover 12 (as shown in FIG. 3), so that the illumination lamp 100 could provide approximately omnidirectional illumination. Thus, the light emitting angle and light use efficiency of the illumination lamp 100 could be greatly increased.

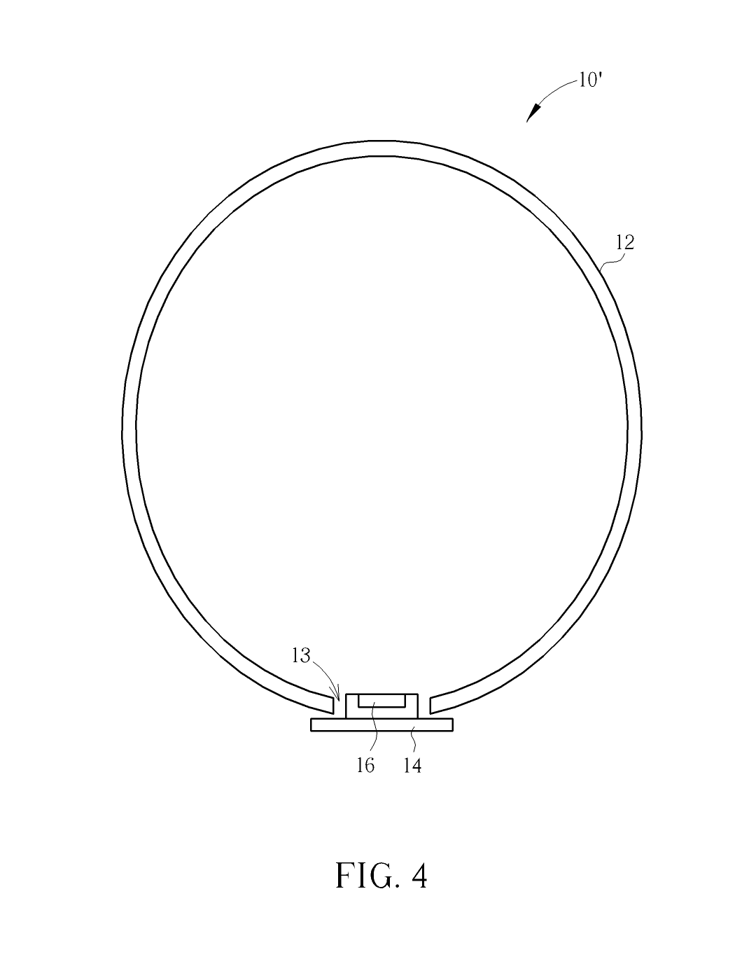

It should be mentioned that the light guide pillar structure mentioned in the first embodiment could be an omissible structure for simplifying the structural design of the illumination lamp provided by the present invention. For example, the related design could be as shown in FIG. 4, which is an internal diagram of an illumination lamp 10′ according to a third embodiment of the present invention. In brief, the illumination lamp 10′ utilizes the top-view light emitting diode 20 to directly emit light to the transmissible lamp cover 12, which is made of reflective material with a light reflectance greater than 90° and a light absorbance less than 1%, so that multiple reflections of light could occur on the transmissible lamp cover 12. Accordingly, light emitted by the top-view light emitting diode 20 could be incident into different positions on the transmissible lamp cover 12 uniformly and partial transmission of light could occur at each light incident position on the transmissible lamp cover 12, so as to increase the overall illumination angle of the illumination lamp 10′. As for the related description for the derived designs of the transmissible lamp cover 12 (e.g. the design in which the transmissible lamp cover 12 could be further made of light scattering material with a haze greater than 50%) and the components of the illumination lamp 10′ (i.e. the circuit board 14 and the top-view light emitting diode 20), it could be reasoned according to the aforesaid embodiments and therefore omitted herein.

Compared with the prior art, the present invention utilizes the side light emitting device to laterally emit light to the transmissible lamp cover to make light capable of being incident into the bottom region of the transmissible lamp cover, so that the illumination angle of the illumination lamp could be increased. The present invention also utilizes the side light emitting device to reflect light toward the side light emitting device, so as to solve the light leakage problem aforementioned in the prior art and increase efficiency of the illumination lamp in use of light. Furthermore, in the present invention, light distribution in the transmissible lamp cover could be more uniform via the high light scattering characteristic of the transmissible lamp cover, and multiple reflections of light could occur on the transmissible lamp cover via the high light reflection characteristic of the transmissible lamp cover. In such a manner, the overall illumination angle of the illumination lamp provided by the present invention could be greatly increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An illumination lamp comprising:
a transmissible lamp cover having an opening;
a circuit board covering the opening; and
a side light emitting device comprising:
a light guide pillar structure having an inclined reflective layer formed therein; and
at least one top-view light emitting diode installed on the circuit board and disposed under the light guide pillar structure, light emitted by the top-view light emitting diode being incident into the light guide pillar structure and then reflected by the inclined reflective layer, so that light could be incident into the transmissible lamp cover laterally.

2. The illumination lamp of claim 1, wherein the light guide pillar structure comprising:
a pillar body disposed on the top-view light emitting diode; and
a recessed structure formed on the pillar body, the inclined reflective layer being formed on the recessed structure and being further used for reflecting light toward the top-view light emitting diode back to the transmissible lamp cover.

3. The illumination lamp of claim 1, wherein the transmissible lamp cover is made of reflective material with a light reflectance greater than 90° and a light absorbance less than 1%.

4. The illumination lamp of claim 3, wherein the transmissible lamp cover is made of light scattering material with a haze greater than 50%.

5. The illumination lamp of claim 4, wherein the transmissible lamp cover is made of microcellular plastic.

6. The illumination lamp of claim 3, wherein a light reflectance of a first region of the transmissible lamp cover relatively close to the side light emitting device is greater than a light reflectance of a second region of the transmissible lamp cover relatively away from the side light emitting device.

7. An illumination lamp comprising:
a transmissible lamp cover having an opening;
a circuit board covering the opening; and
a side light emitting device comprising:
at least one side-view light emitting diode installed on the circuit board for laterally emitting light to the transmissible lamp cover; and
a casing covering the side-view light emitting diode to package the side-view light emitting diode on the circuit board.

8. The illumination lamp of claim 7, wherein the casing is made of high reflective material for reflecting light toward the side-view light emitting diode back to the transmissible lamp cover.

9. The illumination lamp of claim 8, wherein the side light emitting device further comprises a reflective layer formed on the casing and the circuit board, and the reflective layer is used for reflecting light toward and casing and the circuit board back to the transmissible lamp cover.

10. The illumination lamp of claim 7, wherein the transmissible lamp cover is made of reflective material with a light reflectance greater than 90° and a light absorbance less than 1%.

11. The illumination lamp of claim 10, wherein the transmissible lamp cover is made of light scattering material with a haze greater than 50%.

12. The illumination lamp of claim 11, wherein the transmissible lamp cover is made of microcellular plastic.

13. The illumination lamp of claim 10, wherein a light reflectance of a first region of the transmissible lamp cover relatively close to the side light emitting device is greater than a light reflectance of a second region of the transmissible lamp cover relatively away from the side light emitting device.

14. An illumination lamp comprising:
a transmissible lamp cover made of reflective material with a light reflectance greater than 90% and a light absorbance less than 1% and having an opening;
a circuit board covering the opening; and
at least one light emitting diode installed on the circuit board for emitting light to the transmissible lamp cover.

15. The illumination lamp of claim 14, wherein the transmissible lamp cover is made of light scattering material with a haze greater than 50%.

16. The illumination lamp of claim 15, wherein the transmissible lamp cover is made of microcellular plastic.
